(19) United States
(12) Patent Application Publication
(10) Pub. No.: US 2026/0198447 A1
(43) Pub. Date: Jul. 16, 2026

(54) MILKING ARRANGEMENT AT FARM

(71) Applicant: DELAVAL HOLDING AB, Tumba (SE)

(72) Inventors: Dorota ANGLART, Tumba (SE); Anthony BAXTER, Tumba (SE); Mark FUTCHER, Tumba (SE); Christina OHLSSON, Tumba (SE)

(21) Appl. No.: 19/157,719

(22) PCT Filed: Feb. 22, 2024
(86) PCT No.: PCT/SE2024/050171

§ 371 Date: Aug. 19, 2025

(30) Foreign Application Priority Data
Feb. 27, 2023 (SE) 2350219-8

(51) Int. Cl. A01J 5/007; A01J 5/04

(52) U.S. Cl. CPC A01J 5/007; A01J 5/045

(57) ABSTRACT

An arrangement for providing a group score for at least a first group of animals. A control arrangement is configured to: obtain or generate at least one timestamp for a milking event of each animal individual being milked; store a first timestamp corresponding to a first animal individual of the first group being milked; determine whether an animal individual being milked belongs to a second group of animals, and if so; store a second timestamp corresponding to the last animal individual of the first group being milked; obtain or generate a milk sample timestamp for each milk sample of a number of milk samples; and assign a group score to the first group of animals based on values of a biomarker of milk or a constituent in milk for the milk samples between the first and second timestamps.

### TECHNICAL FIELD

The technical field herein relates to an arrangement at a farm.

### BACKGROUND

Milk is analysed at different stages of its production. At a milk producing farm, the milk may be analysed for various reasons, such as:
to establish the health of a relevant milking animal or its nutritional balance status,
for breeding purposes, to document milk data for a relevant milking animal, or
to test whether the milk is suitable for human consumption.

Various biomarkers of milk or constituents in milk may be the object of one or more milk analyses such as, fat content, protein content, somatic cell count, or presence of foreign substances such as antibiotics or pesticides. One or more milk analysis apparatuses may be utilised for detecting and/or measuring such biomarkers or constituents.

WO 2011/124531 discloses a milking system for milking animals and comprises a common milk line connected to a milk storage tank, at least two milking stations connected to the common milk line, and a computer for storing milk quality information and animal identity data. Each milking station is adapted to automatically identify an animal, to automatically extract milk from the animal, and to automatically transfer the milk in the common milk line from the milking station to the milk storage tank. A milk constituent analyzing unit is arranged to analyze milk from the common milk line, wherein the milking stations, the computer, and the milk constituent analyzing unit are communicatively connected, thereby allowing the result of the analysis of the milk with respect to the specific constituent to be associated with the identity of the animal or the identities of the animals, from which the milk was extracted.

WO 2006/105990 discloses a milking device comprising a receiving device on which an analytical unit is disposed in such a manner as to at least partially be in contact with milk from one animal and according to some embodiments with milk from a group of animals. The analytical unit is provided with at least one biochip module for examining the milk.

At milk producing farms, commonly, the milk producing animals are kept in one or more groups of animals. The more animal individuals at a milk producing farm, the more groups of animals.

A group of animals is formed by animal individuals living together as a constellation over a longer period of time. Each group is kept together and handled as one entity e.g., during feeding, milking, etc. Changes may be made in the constellation of a group by adding and/or removing one or a few animal individuals at a time. For instance, the animal individuals may be grouped into the following groups: fresh animal individuals, high producing older animal individuals, high production first offspring animal individuals, and animal individuals with low or excess body condition.

### SUMMARY

Today, a trend is that milk producing farms increase their herd sizes. This leads to more groups of animal individuals being handled at farms. It has been realised that the grouping of animals and handling of the animal groups will become an increasingly important aspect of farm management.

It has been realised that on larger milk producing farms with several groups of animals, milk related parameters can be handled on an animal group level e.g., to establish a general indicator for health and/or the nutritional balance status of the animal individuals of a particular group of animals. For instance, fat contend of the milk produced by a respective group of animals indicates whether the caloric content and/or nutritional content of feed fed to the particular group of animals is appropriate or should be adjusted.

It would be advantageous to achieve an arrangement at a farm providing milk analysis at an animal group level. In particular, it would be desirable to enable an arrangement at a farm, for milk analysis purposes, to distinguish between milk produced by a first group of animals and milk produced by a second group of animals. To better address one or more of these concerns, an arrangement at a farm having the features defined in the independent claim is provided.

According to an aspect there is provided an arrangement at a farm configured for providing a group score for at least a first group of animals based on a biomarker of milk or constituent in milk from the first group of animals, wherein the arrangement comprises a milking entity, an animal identification system, and a milk analysis device configured to measure the biomarker or constituent, wherein animal individuals of the first group of animals and a second group of animals are associated with a respective one of the first and second group of animals at a milking session in which the animal individuals of at least the first and second groups of animals are milked, the animal individuals being identifiable by the animal identification system, wherein a first animal individual and a last animal individual and any further animal individuals of the first group of animals are milked substantially simultaneously and/or successively at the milking session in the milking entity. The milking entity comprises a number of milking positions, each milking position comprising a milk extraction device and being configured for milking one animal individual at a time in a respective milking event. The milking entity further comprises a milk passageway arranged to transport milk from the number of milking positions towards a milk storage tank. The milk analysis device is configured to repeatedly receive milk samples from the milk passageway, resulting in a number of milk samples, the milk analysis device being configured to perform a milk analysis, to measure the biomarker or constituent of individual milk samples, and to provide a value of the measured biomarker or constituent for each individual milk sample. The arrangement at the farm comprises a control arrangement configured to:
obtain an animal identity of a respective animal individual being milked at the milking session in the milking entity from the animal identification system,
obtain or generate at least one timestamp for the milking event of each animal individual being milked at the milking session in the milking entity,
determine whether a respective animal individual being milked at the milking session in the milking entity belongs to the first group of animals,
store a first timestamp corresponding to the first animal individual of the first group of animals being milked at the milking session in the milking entity,
determine whether a respective animal individual being milked at the milking session in the milking entity belongs to the second group of animals, and if so
store a second timestamp corresponding to the last animal individual of the first group of animals being milked at the milking session in the milking entity,
obtain or generate a milk sample timestamp for each milk sample of the number of milk samples from the milk analysis device,
obtain the value of the measured biomarker or constituent for each milk sample of the number of milk samples from the milk analysis device, and
assign a group score to the first group of animals based on the values of the measured biomarker or constituent for the milk samples with milk sample timestamps within a time period from the first timestamp to the second timestamp.

Since the control arrangement is configured to:
obtain an animal identity of a respective animal individual being milked at the milking session in the milking entity from the animal identification system,
obtain or generate at least one timestamp for the milking event of each animal individual being milked at the milking session in the milking entity,
determine whether a respective animal individual being milked at the milking session in the milking entity belongs to the first group of animals,
store a first timestamp corresponding to the first animal individual of the first group of animals being milked at the milking session in the milking entity,
determine whether a respective animal individual being milked at the milking session in the milking entity belongs to the second group of animals, and if so
store a second timestamp corresponding to the last animal individual of the first group of animals being milked at the milking session in the milking entity,
obtain or generate a milk sample timestamp for each milk sample of the number of milk samples from the milk analysis device,
obtain the value of the measured biomarker or constituent for each milk sample of the number of milk samples from the milk analysis device, and
assign a group score to the first group of animals based on the values of the measured biomarker or constituent for the milk samples with milk sample timestamps within a time period from the first timestamp to the second timestamp—the arrangement at the farm is:
   Configured for distinguishing milk produced by animal individuals of the first group of animals from milk produced by animal individuals of the second group of animals, and configured to associate relevant values of the biomarker or constituent of the milk samples to the first group of animals in order to,
   assign a group score to the first group of animals related only to the milk produced by the animal individuals of the first group of animals without having to finish milking the first group of animals before milking animal individuals of the second group of animals in the milking entity.

The group score will thus, provide to a farmer a status of the first group of animals with respect to the milk produced by them, as indicated by the relevant biomarker or constituent. Depending on the value of the group score for the first group of animals, if necessary, the farmer can take action, such as changing the caloric content and/or nutritional content of the feed provided to the first group of animals. Another example is if the measured value of the biomarker indicates a high cell count in the milk of the first group of animals, the farmer can take measures to avoid interaction of the first group of animals with other groups of animals to avoid cross contamination between groups of animals.

It has been realised that when analysing a milk related parameter, as indicated by a biomarker of milk or a constituent in milk, on an animal group level, not all animal individuals of the group need to contribute to the resulting group score. Herein, this realisation has been implemented by refraining from considering, or taking, milk samples that contain both milk from animal individuals belonging to the first group of animals and milk from animal individuals belonging to the second group of animals. Thus, the milk produced by the last milked animal individuals of the first group is not included in the group score for the first group of animals.

Depending on the number of milking positions in the milking entity and on the size of the first group of animals, the milk from the last milked animal individuals of the first group of animals will have a smaller or larger influence on the group score of the first group of animals.

However, since the last milked animal individuals of the first group will be different for each milking session, at subsequent milking sessions, milk from different animal individuals within the first group of animals will contribute to the group scores for the first group of animals.

If deemed of interest, over time the group scores of the first group of animals may be considered to reflect a more complete group score for all animal individuals of the first group of animals. For instance, group scores for the first group of animals taken within a limited time period, such as over 1-3 days or from 2-10 consecutive milking sessions, may provide a more complete view of the group score for the first group of animals than a single group score resulting from one milking session alone.

A group of animals may herein alternatively be referred to as an animal group.

The animals are milk producing animals such as cows, sheep, or goats.

The group score may form a means to assess a status or a condition of the animals of the relevant group as a whole. Alternatively, or additionally, the group score may form a means to assess a constituent aspect and/or a quality aspect of the milk produced by the animals of the relevant group as a whole.

The group score may be a value of a chemical parameter or of a physical parameter, such as a value in the measured unit of the measured biomarker or constituent. The value may be compared to a threshold value or a value range of the biomarker or constituent that represents an approval or a disapproval of the animal individuals of the relevant animal group or of the milk produced by the animal individuals of the relevant animal group. However, the term group score is not limited to being represented by the particular unit of the measured value of the measured biomarker or constituent. Alternatively, the group score for a relevant animal group may simply be a grade on a numbered scale without any unit. A threshold value or a range on the numbered scale may indicate that the relevant value of the biomarker or constituent represents an approval or a disapproval of the animal individuals of the relevant animal group and/or of the milk produced by the animal individuals of the relevant animal group.

The milking entity may form an entire milking parlour i.e., including all milking positions of the milking parlour in which the animals are milked in a milking session.

The milking entity comprises one or more receivers for intermediate reception of the milk being milked in the milking entity. A receiver may form part of the milk passageway.

Animal identification systems are known. The animal identification system of the arrangement is any animal identification system that is able to identify each animal individual of at least the first and second groups of animals. Accordingly, the arrangement at the farm is not limited to any particular kind of animal identification system.

For instance, the animal identification system may read an RFID tag carried by each of the animal individuals and comprises for this purpose one or more tag readers arranged e.g., at an entrance to the milking entity or at the milking positions of the milking entity. Alternatively, the animal identification system may be a system that utilises one or more cameras and image analysis software for identifying each animal individual based on an image of the relevant animal individual.

Each animal individual is associated with one group of animals, such as of the first group of animals, or the second group of animals, or any further group of animals. For instance, the identities of the respective animal individuals are associated with a respective group of animals in a database.

The milk analysis device is configured for analysing the milk in respect of the biomarker or constituent for various reasons, such as:
to establish the health of on group level or its nutritional balance status of the group,
to test whether the milk is suitable for human consumption.

Various natural chemical and/or physical milk related parameters and/or foreign constituents in milk may be the object of the milk analysis in the milk analysis device such as, fat content, protein content, somatic cell count, or presence of foreign substances such as antibiotics or pesticides. The milk analysis device may be configured for analysing milk for more than one biomarker and/or constituent.

Milk analysis devices are known. A milk analysis device may utilise one or more of dry sticks, reagent chemicals, image analysis, colour analysis, ultrasound analysis, infrared light analysis, etc. to measure a biomarker of milk or a constituent in milk e.g., in the form of a natural milk related parameter or a foreign chemical or biological substance present in the milk.

For instance, the milk analysis device may comprise a system as discussed in WO 2019/093907.

The milk analysis device may be arranged for in-line or on-line measuring of a biomarker of milk or a constituent in milk.

Milk samples may be diverted at intervals from the milk passageway and directed to the milk analysis device. The milk analysis device may be arranged in connection with the milk passageway such that the milk analysis device can take i.e., receive, milk samples for analysis directly from the milk passageway. The milk samples are taken from the milk passageway at a portion thereof containing blended milk from all animals being currently milked in the milking entity.

A milking session is a happening in which at least the first and second groups of animals are milked in the milking entity. Such milking sessions are performed one time or a number of times a day, such as twice a day. In preparation for a milking session the first group of animals is lead, directed, or urged to the milking entity. While the animal individuals of the first group of animals are milked substantially simultaneously and/or successively in the milking entity, the second group of animals is lead, directed, or urged to the milking entity for being milked therein subsequently to the first group of animals.

As mentioned above, the milking entity comprises a number of milking positions, each milking position comprising a milk extraction device and being configured for milking one animal individual at a time. The milking positions are configured to milk a particular kind of animal. For instance, each milking position comprises a relevant number of teat cups for the particular kind of animal.

Each milking position of the number of milking positions is configured to milk one animal at a time. Accordingly, each milking position comprises at least two teat cups, a vacuum connection for supplying vacuum to the teat cups, and at least one milk conduit for conducting milk from the milking position towards the milk passageway.

As mentioned above, the milk passageway is arranged to transport milk from the number of milking positions. Accordingly, in the milk passageway blended milk from the number of milking positions is transported. That is, the animal individuals being milked at each particular point in time during the milking session contribute to the blended milk in the milk passageway at the relevant point in time.

The milk passageway may comprise one or more of the following components: a milk line with a milking vacuum therein arranged for connecting the number of milking positions to a receiver, the receiver, a milk pump, a conduit downstream of the receiver. As such, the milk passageway components lead towards a milk storage tank.

The milk storage tank may be e.g., a stationary milk cooling tank and/or a mobile milk tank, such as a trailer-bound milk tank.

The control arrangement may be a dedicated control arrangement provided for the assigning of group scores for groups of animals being milked in the milking entity. Alternatively, the control arrangement may form part of one or more control arrangements of the milking entity, the animal identification system, the milk analysis device, and/or other units at the farm or remote from the farm, such as a computer at the farm or a server located remote from the farm.

The control arrangement may be configured to sort and/or store at least animal identities, timestamps, milk sample timestamps, and values of the measured biomarker or constituent. Moreover, the control arrangement may be configured to calculate a value, such an average value of a series of values.

The control arrangement may be a single control arrangement. Alternatively, the control arrangement may be a distributed control arrangement including two or more separate control arrangements e.g., including a control arrangement of one or more of the milking entity, the animal identification system, and/or the milk analysis device.

The control arrangement may comprise a calculation unit, a memory unit, and communication devices for receiving and sending information and/or data related to one or more of animal identities, milking events, timestamps, milk sample timestamps, values of the measured biomarker or constituent, and signals such as alerts to a farmer.

A timestamp is a sequence of characters or encoded information identifying when a certain event occurred, such as the herein discussed first timestamp representing the first animal individual of the first group of animals being milked, second timestamp representing the last animal individual of the first group of animals being milked, and milk sample timestamps representing milk sampling events.

According to embodiments, the control arrangement may be further configured to:
determine a first instance in time when all animal individuals being milked substantially simultaneously at the milking session in the milking entity belong to the second group of animals,
store a third timestamp corresponding to the first instance in time,
determine whether a respective animal individual being milked at the milking session in the milking entity belongs to a third group of animals, and if so
store a fourth timestamp corresponding to a last animal individual of the second group of animals being milked at the milking session in the milking entity, and
assign a group score to the second group of animals based on the values of the measured biomarker or constituent for the milk samples with milk sample timestamps within a time period from the third timestamp to the fourth timestamp. In this manner, the arrangement at the farm may be:
   Configured for distinguishing milk produced by animal individuals of the second group of animals from milk produced by animal individuals of the first group of animals and the third group of animals, and
   configured to associate relevant values of the biomarker or constituent of the milk samples to the second group of animals in order to,
   assign a group score to the second group of animals related only to the milk produced by the animal individuals of the second group of animals without having to finish milking the first group of animals before starting to milk animal individuals of the second group of animals in the milking entity and without having to finish milking the second group of animals before milking animal individuals of the third group of animals in the milking entity.

Again, it has been realised that when analysing a milk related parameter, as indicated by a biomarker of milk or a constituent in milk, on an animal group level, not all animal individuals of the group need to contribute to the resulting group score. In these embodiments, this realisation has been implemented by refraining from considering, or taking, milk samples that contain both milk from animal individuals belonging to the first group of animals and milk from animal individuals belonging to the second group of animals as well as refraining from considering, or taking, milk samples that contain both milk from animal individuals belonging to the second group of animals and milk from animal individuals belonging to the third group of animals. Thus, the milk produced by the first milked animal individuals of the second group of animals and the last milked animal individuals of the second group is not necessarily included in the group score for the second group of animals.

According to embodiments, the control arrangement may be further configured to:
compare the group score assigned to the first group of animals with a reference score and/or a reference score range, and
issue a signal if the group score assigned to the first group of animals deviates from the reference score and/or is outside the reference score range. In this manner, a farmer may be notified directly or indirectly by the signal that the first group of animals may require attention in order for its group score to again correspond to the reference score or fall within the reference score range.

According to embodiments, the control arrangement may be further configured to:
assign a start timestamp to a start of the milking event and a stop timestamp to a stop of the milking event for each animal individual, and
associate each individual milk sample of the number of milk samples with animal individuals having been milked based on the respective milk sample timestamp assigned to each individual milk sample and the start and stop timestamps for each animal individual. In this manner, further detail with respect to the individual milk samples and the contribution of respective animal individuals to each milk sample may be provided.

For instance, such further detail may be utilised for comparing a value of the measured biomarker or constituent for a number of milk samples from different milking sessions in order to assess whether the milk of a particular animal individual influences the value of the measured biomarker or constituent in a particular manner and thus, to assess whether that particular animal individual requires special attention e.g., in the form of changes in the caloric and/or nutritional content of the feed fed to that animal individual.

Further features of, and advantages with, the invention will become apparent when studying the appended claims and the following detailed description.

### BRIEF DESCRIPTION OF THE DRAWINGS

Various aspects and/or embodiments, including particular features and advantages, will be readily understood from the example embodiments discussed in the following detailed description and the accompanying drawings, in which:

FIG. 1 schematically illustrates embodiments of an arrangement at a farm,

FIG. 2 schematically illustrates, in more detail, the arrangement at the farm of FIG. 1,

FIG. 3 schematically illustrates a milking entity according to embodiments,

FIG. 4 shows a timeline representing an exemplary milking session in a milking entity, and

FIG. 5 schematically illustrates a control arrangement of an arrangement at a farm.

### DETAILED DESCRIPTION

Aspects and/or embodiments will now be described more fully. Like numbers refer to like elements throughout. Well-known functions or constructions will not necessarily be described in detail for brevity and/or clarity.

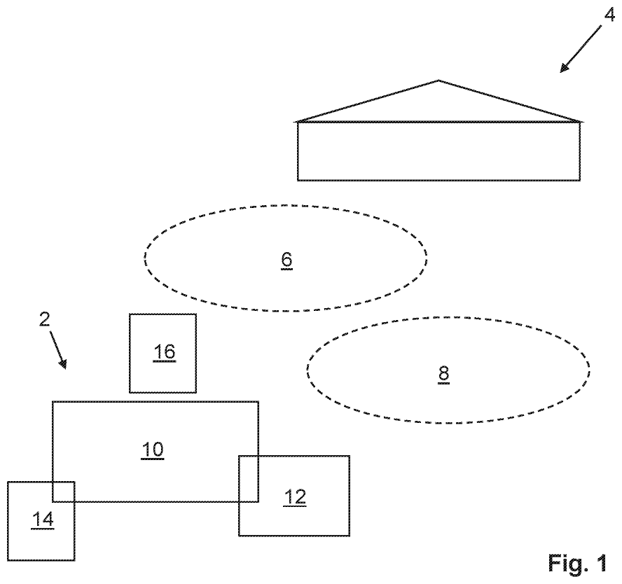

FIG. 1 illustrates embodiments of an arrangement 2 at a farm 4.

The farm 4 is a milk producing farm at which milk producing animals are held in at least two groups of animals, such as a first group 6 of animals and a second group 8 of animals.

A group of animals is formed by animal individuals living together as a constellation. Each group is kept together and handled as one entity e.g., during feeding, milking, etc. Changes may be made in the constellation of a group by adding and/or removing one or a limited number of animal individuals at a time. Specifically, herein, animal individuals of the first group 6 of animals and the second group 8 of animals are associated with a respective one of the first and second group 6, 8 of animals at a milking session in which the animal individuals of at least the first and second groups 6, 8 of animals are milked.

The groups 6, 8 of animals are held separated from each other e.g., in separate buildings, stockyards, pastures, etc.

The arrangement 2 at the farm 4 is configured for providing a group score for at least the first group 6 of animals. The group score for a relevant group of animals is based on a biomarker of milk or a constituent in milk extracted from the relevant group of animals in the milking session.

The arrangement 2 at the farm 4 comprises a milking entity 10, an animal identification system 12, and a milk analysis device 14 configured to measure the biomarker or constituent.

The milking entity 10 may be arranged outdoors, under a protective roofing, or in a building e.g., depending on environmental conditions. The milking entity 10 may be arranged in its dedicated building or in a building also housing one or more of the groups 6, 8 of animals.

The animal identification system 12 is configured to identify animal individuals in connection with the milking session. Accordingly, the animal individuals of the groups of animals are identifiable by the animal identification system 12.

Over the duration of the milking session, at least the first and second groups 6, 8 of animals are milked in the milking entity 10. A first animal individual and a last animal individual and any further animal individuals of the first group 6 of animals are milked substantially simultaneously and/or successively at the milking session. Similarly, for the second group of animals and for any further group of animals, a first animal individual and a last animal individual and any further animal individuals of the relevant group of animals are milked substantially simultaneously and/or successively at the milking session.

The duration of the milking session depends on the size of the animal groups and the number of animal groups being milked at the farm 4. One milking session may end once all groups of animals have been milked. One milking session may end, or may be interrupted, for cleaning of the milking entity 10. A second milking session in the milking entity 10 may commence a shorter or longer time period after ending a preceding first milking session. First and second milking sessions may be performed one immediately after the other. In such cases, the first milking session may be considered to end, and the second milking session may be considered to start, when the first group of animals returns for being milked a second time in the milking entity 10.

For milking in the milking entity 10, the groups 6, 8 of animals are led, guided, or directed one after the other to the milking entity 10. The animal individuals of each group 6, 8 of animals are milked substantially simultaneously and/or successively at the milking session.

In order to efficiently utilise the milking entity 10, the second group 8 of animals is admitted to the milking entity 10 during a transitional period of the milking session when milking of the first group 6 of animals has not yet been completed. That is, during the transitional period animal individuals of the first and second animal groups 6, 8 are milked simultaneously in the milking entity 10.

To cope with the provision of a reliable group score for at least the first group 6 of animals, despite animal individuals of the second group 8 of animals being milked simultaneously with the first group 6 of animals, the arrangement 2 at the farm 4 comprises a control arrangement 16 configured to distinguish between milk produced by the first group 6 of animals and milk produced by the second group 8 of animals, see further below.

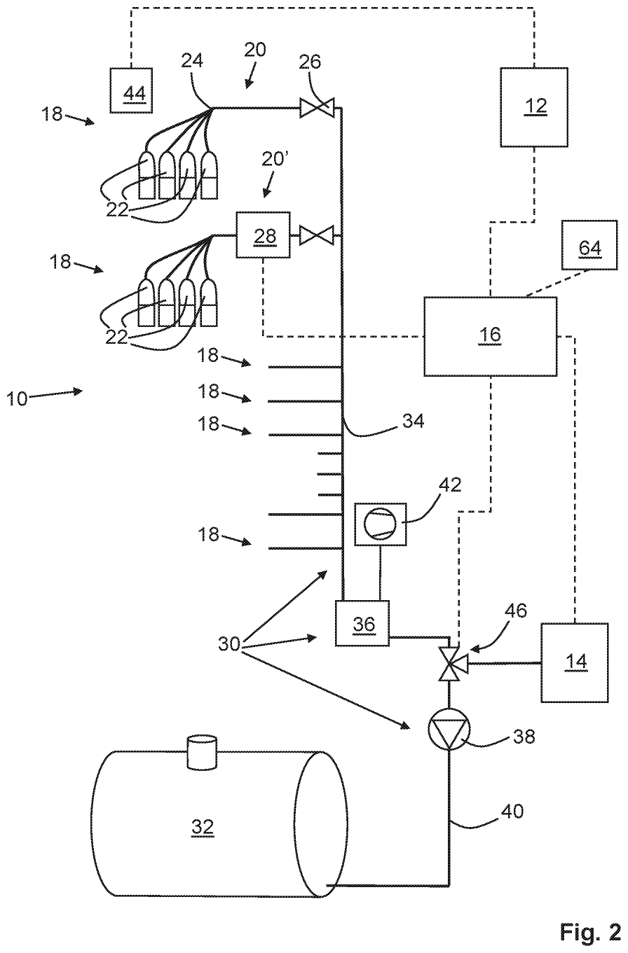

FIG. 2 schematically illustrates, in more detail, the arrangement 2 at the farm 4 discussed above with reference to FIG. 1. Accordingly, in the following reference is also made to FIG. 1.

The milking entity 10 comprises a number of milking positions 18. In the illustrated embodiments, the milking positions 18 are arranged in a parallel milking stall configuration.

Each milking position 18 comprises a milk extraction device 20, 20′ and is configured for milking one animal individual at a time. In FIG. 2, the milk extraction device 20, 20′ is only shown in two of the milking positions 18 for the sake of simplicity.

The milk extraction device 20, 20′comprises at least one teat cup 22. In the illustrated embodiments, each milk extraction device 20, 20′comprises four teat cups 22 and accordingly, may be arranged for milking cows.

The milking positions 18 of the milking entity 10 may comprise milk extraction devices of the same kind at all milking positions 18 but in order to explain different kinds of milk extraction devices, two kinds of milk extraction devices 20, 20′have been illustrated in FIG. 2.

A first kind of milk extraction device 20, is of a simple kind and comprises only the teat cups 22, short and long milk conduits 24, and a shut-off valve 26. Thus, a cost-efficient milk extraction device 20 may be provided at each milking position 18.

A second kind of milk extraction device 20′, is of a more advanced kind and comprises additional components, such as a milk meter 28 that may measure e.g., milk flow rate and/or total extracted amount of milk from an animal individual at a milking event thereof in the milking position 18. The milk meter 28 communicates directly or indirectly with the control arrangement of the arrangement 2 at the farm 4. Thus, additional functionality may be provided at the milking positions 18 and animal individual information may be provided from the milking entity 10 to the control arrangement 16.

The milk meter 28 shown in FIG. 2 is arranged to measure the flow and/or amount of milk from an entire udder of an animal individual being milked. Alternatively, a milk meter arranged to measure flow and/or amount of milk per udder partition, such as udder quarter, may be utilised. In such case, individual milk conduits lead from the teat cups to the milk meter.

The milking entity 10 further comprises a milk passageway 30 arranged to transport milk from the number of milking positions 18 towards a milk storage tank 32. In the milk passageway 30, blended milk from the number of milking positions 18 is transported toward the milk storage tank 32.

In the illustrated embodiments, the milking entity 10 comprises a common milk line 34, a milk receiver 36, a milk pump 38, arranged in a conduit 40 leading from the receiver 36 to the milk storage tank 32. The common milk line 34 is connected to the milk receiver 36 and the receiver 36 is connected to the conduit 40 leading from the receiver 36 to the milk storage tank 32.

From the individual milking positions 18, in the common milk line 34, the milk is transported towards the milk receiver 36. The closer to the receiver 36, the more milk from more animal individuals currently being milked is blended in the common milk line 34. Accordingly, in the illustrated embodiments, the milk passageway 30 comprises a portion of the common milk line 34 closest to the milk receiver 36 i.e., where blended milk from all milking positions 18 flows through the common milk line 34, the receiver 36, the milk pump 38, and the conduit 40 leading from the receiver 36 to the tank 32.

The milking entity 10 further comprises a vacuum system 42 connected to the receiver 36 for providing a milking vacuum in the common milk line 34 and the teat cups 22 for milking the animal individuals at the milking positions 18. Downstream of the receiver 36, atmospheric pressure may prevail in the milk passageway 30.

The milk storage tank 32 may be a milk cooling tank and accordingly, the milk stored therein is cooled to a suitable storage temperature, such as 4 degrees Celsius.

In the illustrated embodiments, the animal identification system 12 comprises RFID tag readers 44 (only one is shown in FIG. 2) arranged at the milking positions 18. In a known manner, the RFID tag readers 44 read RFID tags carried by the animals to identify animal individuals in connection with the milking session.

The milk analysis device 14 is configured to repeatedly receive milk samples from the milk passageway 30. This results in a number of milk samples. The milk analysis device 14 is configured to perform a milk analysis and to measure a biomarker or constituent of interest of individual milk samples of the number of milk samples. The measuring of the biomarker or constituent results in a value of the measured biomarker or constituent. A value of the biomarker or constituent may be provided for each individual milk sample of the number of milk samples.

Accordingly, milk samples are provided at intervals from the milk passageway 30 to the milk analysis device 14.

For instance, a milk sample may be provided every 6^{th} minute, or within a range of every 3^{rd} 9^{th} minute, to the milk analysis device 14 during the milking session.

The milk sampling rate may be determined by the time it takes to measure the biomarker or constituent of a milk sample and to clean relevant parts of the milk analysis device 14 in between measuring of two consecutive milk samples.

The milk sampling rate may be determined by the time period needed for a milking event of one animal individual, which may be within a range of 5 -15 minutes, to ensure at least one milk sample being taken while milking each animal individual of a relevant animal group.

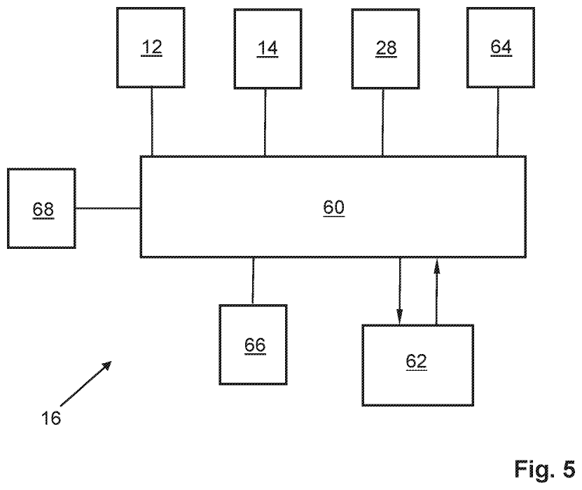

Embodiments of the control arrangement 16 are discussed in more detail below with reference to FIG. 5. However, the control arrangement 16 communicates with the animal identification system 12 and with the milk analysis device 14. Such communication may be via wired and/or wireless communication. Such communication between the control arrangement 16 and the animal identification system 12 and the milk analysis device 14, respectively, may be directly or indirectly via intermediate communication devices.

The control arrangement 16 is configured to:
Obtain an animal identity of a respective animal individual being milked at the milking session in the milking entity 10 from the animal identification system 12.
Obtain or generate at least one timestamp for the milking event of each animal individual being milked at the milking session in the milking entity. For instance, the at least one timestamp may be a start of the milking event of the relevant animal individual, or when a minimum milk flow has been reached for, or a minimum amount of milk has been extracted from, the relevant animal individual during the milking event. The at least one timestamp may be obtained from the animal identification system 12 in connection with an animal individual being identified at a milking position 18, or it may be obtained from the milk meter 28 when a predetermined milk related parameter is fulfilled such as a minimum amount of extracted milk, or it may be generated by the control arrangement 16 itself upon receiving certain predetermined data from the animal identification system 12 or the milk meter 28 or suitable element of the milking entity 10.
Determine whether a respective animal individual being milked at the milking session in the milking entity 10 belongs to the first group 6 of animals. For instance, a database of the control arrangement 16 may comprise one or more data tables including information about the group belongings of the animal individuals being milked in the milking entity 10.
Store a first timestamp corresponding to the first animal individual of the first group 6 of animals being milked at the milking session in the milking entity 10. Accordingly, the first timestamp is linked to a point in time when milking of the first group 6 of animals commences.
Determine whether a respective animal individual being milked at the milking session in the milking entity 10 belongs to the second group 8 of animals, and if so;
Store a second timestamp corresponding to the last animal individual of the first group 6 of animals being milked at the milking session in the milking entity 10. Accordingly, the second timestamp is linked to a point in time when still all animal individuals being milked in the milking entity 10 belonged to the first group 6 of animals.
Obtain or generate a milk sample timestamp for each milk sample of the number of milk samples. The milk sample timestamp may represent a point in time when the relevant milk sample is taken from the milk passageway 30. The milk sample timestamp may be obtained from the milk analysis device 14 or it may be generated by the control arrangement 16 itself e.g., upon controlling the diverting of a milk sample to the milk analysis device 14. Milk samples are taken during the milking session. Accordingly, milk sample timestamps are obtained or generated during the milking session.
Obtain the value of the measured biomarker or constituent for each milk sample of the number of milk samples from the milk analysis device 14.
Assign a group score to the first group 6 of animals based on the values of the measured biomarker or constituent for the milk samples with milk sample timestamps within a time period from the first timestamp to the second timestamp.

In this manner, in the assigned group score for the first group 6 of animals, milk extracted in the milking entity 10 during a transitional period of the milking session when animal individuals of the first and second animal groups 6, 8 are milked simultaneously in the milking entity 10 is excluded. Accordingly, the group score is based only on milk from animal individuals of the first group 6 of animals.

The group score provides a status of the first group 6 of animals with respect to the milk produced by them, as indicated by the relevant biomarker or constituent.

More generally, a group score for a group of animals with respect to the milk produced by them, as indicated by the relevant biomarker or constituent, provides a status of the relevant animal group. The group score may be stored for future reference and/or may lead to one or more actions in relation to the relevant group of animals, such as changing feed rations and/or of proportions of feed content to change the caloric content and/or nutritional content of the feed fed to the relevant group of animals.

As mentioned above, the group score is not limited to being represented by the particular unit of the measured value of the measured biomarker or constituent but may alternatively be represented on a numbered scale without any unit.

The assigning of the group score based on the values of the measured biomarker or constituent may be performed in any suitable number of ways. Accordingly, the assigning of the group score is not limited to any particular way of assigning the group score. For instance, the group score for a relevant group of animals may be calculated by the control arrangement 16 as an average of all the values of the measured biomarker or constituent for the milk samples with milk sample timestamps within the time period during which only animals from the relevant group of animals are milked.

According to some embodiments, the control arrangement 16 may be configured to:
calculate an average group score for the first group 6 of animals based on a number of group scores for the first group 6 of animals assigned in a number of consecutive milking sessions. In this manner, a likelihood that the average group score is based on milk samples collectively containing milk from all animal individuals of the first group 6 of animals is improved over that of a group score from a single milking session based on milk from all but the last milked animal individuals of the first group 6 of animals.

The control arrangement 16 may be further configured to:
Compare the group score assigned to the first group 6 of animals with a reference score and/or a reference score range.
Issue a signal if the group score assigned to the first group 6 of animals deviates from the reference score and/or is outside the reference score range.

Thus, a farmer may be notified by the signal and may take an appropriate action in relation to the first group 6 of animals. The signal may be issued via a signalling device 64 e.g., a mobile telephone or a computer.

According to some embodiments, such as the illustrated embodiments, the milk passageway 30 comprises a milk sample outtake 46 and the control arrangement 16 is further configured to: —control that milk samples are repeatedly diverted from the milk passageway 30 via the milk sample outtake 46 to the milk analysis device 14. In this manner, the control arrangement 16 may control the taking of milk samples from the milk passageway 30.

For instance, the milk sample outtake 46 may comprise a valve or a pump or a combination thereof that is controlled by the control arrangement 16, either directly or indirectly e.g., via the milk analysis device 14.

One or several pumps and other flow control devices (not shown) may be provided for transferring the milk samples from the milk sample outtake 46 to analysis elements within the milk analysis device 14. Such pump/s and/or other flow control devices may form part of the milk analysis device 14 or may be separate therefrom.

According to some embodiments, such as the illustrated embodiments, the control arrangement 16 may be further configured to: —control that the milk samples are diverted with a frequency within a range of 3-9 minutes.

In order to assign a group score to also the second group 8 of animals, the control arrangement 16 may be further configured to:
Determine a first instance in time when all animal individuals being milked substantially simultaneously at the milking session in the milking entity 10 belong to the second group 8 of animals. For instance, based on information from the animal identification system 12, optionally in combination with information from milk meters 28 at the milking positions 18, the control arrangement 16 is able to determine when all animals in the milking entity 10 belong to the second group 8 of animals.
Store a third timestamp corresponding to the first instance in time. Thus, the third timestamp corresponds to a point in time when the milk in the milk passageway 30 is blended milk from animal individuals belonging only to the second group 8 of animals.
Determine whether a respective animal individual being milked at the milking session in the milking entity 10 belongs to a third group of animals, and if so;
Store a fourth timestamp corresponding to a last animal individual of the second group of animals being milked at the milking session in the milking entity 10.
Assign a group score to the second group 8 of animals based on the values of the measured biomarker or constituent for the milk samples with milk sample timestamps within a time period from the third timestamp to the fourth timestamp.

In this manner, in the assigned group score for the second group 8 of animals, milk extracted in the milking entity 10 during a transitional period of the milking session when animal individuals of the first and second animal groups 6, 8 are milked simultaneously and during a transitional period of the milking session when animal individuals of the second and the third animal groups are milked simultaneously are excluded. Accordingly, the group score is based only on milk from animal individuals of the second group 8 of animals.

According to some embodiments, the control arrangement 16 may be further configured to:
interrupt a taking of milk samples from the milk passageway 30 in response to an identification of a first animal individual belonging to the second group of animals being milked at the milking session in the milking entity 10. In this manner, milk samples containing blended milk from animal individuals from both the first and second group 6, 8 of animals are avoided being taken. Thus, the number of milk samples will not contain milk samples containing blended milk from animal individuals from both the first and second group 6, 8 of animals.

Alternatives to such embodiments may be to take milk samples continuously and either to refrain from analysing milk samples containing blended milk from animal individuals from two different animal groups or to refrain from considering analysis results from milk samples containing blended milk from animal individuals from two different animal groups. Accordingly, such milk samples do not form part of the number of milk samples.

According to some embodiments, the control arrangement 16 may be further configured to:
resume the taking of milk samples from the milk passageway 30 at the first instance in time.

In this manner, the taking of milk samples from the milk passageway 30 may be resumed only once the milk extracted from the animal individuals in the milking entity 10 is a blended milk from animal individuals belonging only to the second group 8 of animals.

According to some embodiments, the control arrangement 16 may be further configured to:
Assign a start timestamp to a start of the milking event and a stop timestamp to a stop of the milking event for each animal individual.
Associate each individual milk sample of the number of milk samples with animal individuals having been milked based on the respective milk sample timestamp assigned to each individual milk sample and the start and stop timestamps for each animal individual.

In this manner, the animal individuals contributing to each milk sample of the number of milk samples can be traced. This provides basis for further assessment of the biomarker or constituent on a level of each animal individual.

A physical layout of the milking entity 10, such as milking position 18 locations in relation to a location of the sample outtake 46 in the milk passageway 30, may be considered in order to ensure a proper associating of each individual milk sample with the animal individuals contributing to a relevant milk sample.

According to some embodiments, the control arrangement 16 may be further configured to:
associate each animal individual being milked at the milking session with one of the milking positions 18 of the number of milking positions 18. In this manner, basis for further assessing the animal individuals contributing to each milk sample of the number of milk samples may be established. The value of the measured biomarker or constituent for a particular milk sample thus, may be contributed to a limited number of animal individuals of the relevant group of animals.

More specifically, with knowledge about the physical layout of the milking entity, such as the distance between each milking position 18 and the sample outtake 46, the flow rate of milk in various parts of the milk passageway 30 from the respective milking positions 18 to the sample outtake 46, etc.—the knowledge about in which of the milking positions each animal individual is milked will enable establishing the animal individuals contributing to each milk sample.

The physical layout of the milking entity 10 may be represented in the control arrangement 16 in a suitable manner such that the control arrangement 16 is able to calculate when the milk from each milking position 18 arrives at the sample outtake 46 and contributes to a respective milk sample of blended milk taken at the sample outtake 46.

This may also provide basis for further assessment of the biomarker or constituent on a level of each animal individual e.g., if the measured value of the biomarker or constituent of a particular milk sample deviates from the measured values of other milk samples.

Over time, with data from a number of consecutive milking sessions, a value of the biomarker or constituent for a particular animal individual may be established.

According to some embodiments, wherein each milk extraction device 20′ comprises a milk meter 28 configured to provide milk flow rate data and/or milk yield data, the control arrangement 16 may be further configured to:
record milk flow rate and/or accumulated milk yield provided by the milk meters 28 of the milk extraction devices 20′ as a function of time for each animal individual being milked at the miking occasion,
correlate the milk flow rate and/or the accumulated milk yield of animal individuals being milked at the milking session with individual milk samples based on the respective milk sample timestamps and the start and stop timestamps of each animal individual, and
determine a contribution to each individual milk sample of each animal individual being milked at the respective milk sample timestamp based on the associated milking position of each animal individual and on the milk flow rate and/or the accumulated milk yield of the animal individuals being milked at the respective individual milk sample timestamp. In this manner, basis for assessing the relative contribution of each animal individual to each milk sample may be established.

For instance, it may be established which animal individuals contribute the most to the blended milk from which a relevant milk sample is taken and accordingly, which animal individuals influence the measured value of the biomarker or constituent of a relevant milk sample. This may provide basis for further assessment of the biomarker or constituent on a level of each animal individual.

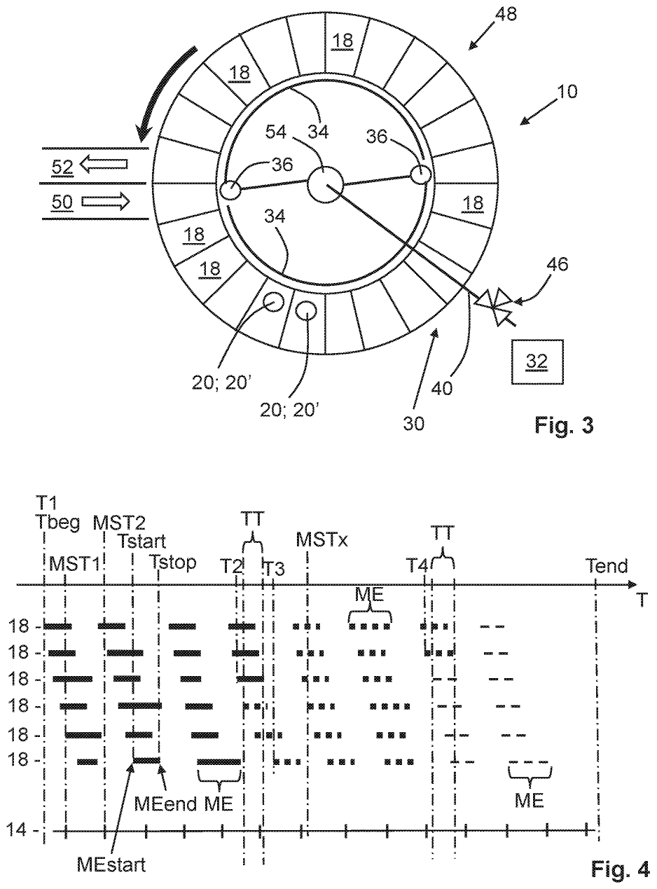

FIG. 3 schematically illustrates a milking entity 10 according to embodiments. The milking entity 10 is a milking entity of an arrangement 2 at a farm 4 as discussed herein. In the following, where applicable, reference is also made to FIGS. 1 and 2.

In these embodiments, the number of milking positions 18 are arranged on a rotary platform 48. That is, the milking positions 18 of the milking entity 10 are arranged on the rotary platform 48.

Rotary platforms for milking animals thereon are known and need no further explanation. Animal individuals enter the milking positions 18 on the rotary platform 48 via an entrance lane 50 and leave the milking positions 18 and the platform 48 via an exit lane 52. As discussed above, each of the milking positions 18 comprises a milk extraction device 20, 20′.

The milking entity comprises all of the milking positions arranged on the rotary platform.

Depending on the number of milking positions on the rotary platform, the blended milk from all milking positions on the platform may flow via one receiver of the milk passageway to a milk storage tank, as discussed above. A portion of the milk passageway leading from the receiver to the milk storage tank extends via a centrally arranged so-called swivel configured to decouple a portion of the milk passageway downstream of the platform from the rotation of the platform.

In the illustrated embodiments of FIG. 3 a larger type of rotary platform 48 is schematically shown, wherein the milking positions 18 are connected to two or more receivers 36. In this example, milk from the milking positions 18 on each half of the platform 48 is conducted to a respective receiver 36. A respective common milk line 34 leads from the relevant milking positions 18 to a milk receiver 36, a conduit 40 leads to a milk storage tank 32. One or more pumps (not shown) for transporting milk to the tank 32 may be arranged in the conduit 40 downstream of the receiver 34.

The conduit 40 extends via a centrally arranged so-called swivel 54 configured to decouple a portion of the conduit 40 downstream of the platform 48 from the rotation of the platform 48.

A sample outtake 46 is arranged in the milk passageway 30 e.g., in the conduit 40 as indicated in FIG. 3.

FIG. 4 shows a timeline T representing an exemplary milking session in the milking entity 10 of the arrangement 2 at the farm 4 discussed above with reference to FIGS. 1-3.

Accordingly, in the following reference is also made to FIGS. 1-3.

Along the timeline T, the various kinds of timestamps discussed above are indicated, see further below.

The milking session begins at a point in time, Tbeg, and ends at a point in time, Tend. During the milking session, animal individuals of at least a first animal group 6 and a second animal group 8 are milked in the milking entity 10. In FIG. 4, milking a of a third animal group is indicated.

In parallel with the timeline T, milking events ME of animal individuals at milking positions 18 of the milking entity 10 are indicated with line segments. In FIG. 4, only some of the milking events ME in some of the milking positions 18 of the milking entity 10 are shown.

Each thick full line segment indicates a milking event ME of an animal individual of the first group 6 of animals. Each thick dotted line segment indicates a milking event ME of an animal individual of the second group 8 of animals. Each thin broken line segment indicates a milking event ME of an animal individual of the third group of animals. Further groups of animals may be milked before the end of the milking session Tend.

Each milking event ME has a start time, MEstart, and an end time, MEend. Accordingly, as stated above, during the milking session, in each milking position 18 one animal individual at a time is milked in a respective milking event ME.

The start timestamp, Tstart, for each milking event ME may correspond to the start time MEstart. The stop timestamp, Tstop, for each milking event ME may correspond to the end time MEend. Alternatively, the start and stop timestamps of each milking event may be set when exceeding, respectively falling below, a minimum milk flow during a milking event ME. The least one timestamp for the milking event of each animal individual being milked at the milking session in the milking entity 10 may be the start timestamp Tstart for the relevant milking event ME.

The milking session includes transitional periods, TT, during which animal individuals of two groups of animals are milked in the milking entity 10. As discussed above, the control arrangement 16 is configured to identify transitional periods TT and to exclude milk extracted during those transitional periods in the calculation of the group score of a relevant group of animals.

The first timestamp, T1, corresponding to the first animal individual of the first group 6 of animals being milked at the milking session, is indicated on the timeline T. The first timestamp T1 coincides with the beginning of the milking session Tbeg if the first timestamp T1 corresponds to the start of the milking event ME of the first animal individual of the first group 6 of animals. If the first timestamp T1 relates to a different part of the milking event ME of the first animal individual of the first group 6 of animals, the first timestamp T1 corresponds to a point in time after the beginning of the milking session Tbeg. Such a different part of the milking event ME may be the reaching of a minimum milk flow rate or a minimum amount of extracted milk from the first animal individual of the first group 6 of animals.

The second timestamp, T2, corresponding to the last animal individual of the first group 6 of animals being milked at the milking session, is indicated on the timeline T. The second timestamp T2 corresponds to a point in time when still all animal individuals being milked in the milking entity 10 belonged to the first group 6 of animals.

The third timestamp, T3, corresponding to the first instance in time when all animal individuals being milked substantially simultaneously at the milking session in the milking entity 10 belong to the second group 8 of animals, is indicated on the timeline T.

The fourth timestamp, T4, corresponding to a last animal individual of the second group of animals being milked at the milking session in the milking entity 10, is indicated on the timeline T.

The control arrangement 16 may set the respective timestamps T1-T4 based on information provided from the milking entity 10 in combination with information provided by the animal identification system 12.

In parallel with the timeline T, milk samples from the milk passageway 30 are indicated with vertical dashes along a line representing the milk analysis device 14.

The number of milk samples analysed in the milk analysis device 14 may include all milk samples from the milk passageway. In such case, no milk samples are taken during the transitional periods TT, as indicated for the second transitional period TT in FIG. 4. Alternatively, the number of milk samples analysed in the milk analysis device 14 do not include all milk samples from the milk passageway 30. In such case, e.g. the milk samples taken during the transitional periods TT are not analysed, such as the milk sample taken during the first transitional period TT in FIG. 4.

For each milk sample of the number of milk samples, the milk analysis device 14 provides a milk sample timestamp MST1, MST2, MSTx, etc. The milk sample timestamps MST1, MST2. MSTx, etc are communicated to the control arrangement 16 from the milk analysis device 14. FIG. 5 schematically illustrates a control arrangement 16 of an arrangement 2 at a farm 4 as discussed above with reference to FIGS. 1-4. Accordingly, in the following reference is also made to FIGS. 1-4.

The control arrangement 16 comprises at least one calculation unit 60 which may take the form of substantially any suitable type of processor circuit or microcomputer, e.g. a circuit for digital signal processing (digital signal processor, DSP), a Central Processing Unit (CPU), a processing unit, a processing circuit, a processor, an Application Specific Integrated Circuit (ASIC), a microprocessor, or other processing logic that may interpret and execute instructions, such as program instructions and calculation instructions, etc.

The herein utilised expression calculation unit 60 may represent a processing circuitry comprising a plurality of processing circuits, such as, e.g., any, some or all of the ones mentioned above.

The control arrangement 16 may comprise a memory unit 62. The calculation unit 60 is connected to the memory unit 62, which provides the calculation unit 60 with, for example, stored programme code and/or stored data which the calculation unit 60 needs to enable it to do calculations. The calculation unit 60 may also be adapted to storing partial or final results of calculations in the memory unit 62. The memory unit 62 or part of the memory unit 62 may form part of a circuitry that also forms the calculation unit 60.

The memory unit 62 may comprise a physical device utilised to store data or programs, i.e. sequences of instructions on a temporary or permanent basis. According to some embodiments, the memory unit 62 may comprise integrated circuits comprising silicon-based transistors. The memory unit 62 may comprise e.g. a memory card, a flash memory, a USB memory, a hard disc, or another similar volatile or non-volatile storage unit for storing data such as e.g. ROM (Read-Only Memory), PROM (Programmable Read-Only Memory), EPROM (Erasable PROM), EEPROM (Electrically Erasable PROM), etc. in different embodiments.

The clock or timer circuit 66 may be utilised for obtaining or generating timestamps, such as timestamps of milking events, first-fourth timestamps, milk sample timestamps, etc. The clock or timer circuit 66 may be utilised for synchronising clock or timer circuits of one or more of connected devices or systems e.g., of the milk analysis device 14, in the event that the milk sample timestamps are generated by the milk analysis device 14 in order to coordinate the milk sample timestamps with the timestamps of the milking events, first fourth timestamps, etc.

The calculation unit 60 is connected to various devices, systems, etc of the arrangement 2 at the farm 4 in order to provide the group score for animal groups. Accordingly, the control arrangement 16 is provided with respective devices (not shown) for receiving and/or sending input and output signals.

Each of connections to the respective devices for receiving and sending input and output signals may take the form of one or more from among a cable, a data bus, e.g. a CAN (controller area network) bus, a MOST (media orientated systems transport) bus or some other bus configuration, or a wireless connection.

The input and output signals may comprise waveforms, pulses or other attributes, which can be detect as information by signal receiving devices, and which can be converted to signals processable by the calculation unit 60. Input signals are supplied to the calculation unit 60 from the input receiving devices. Output signal sending devices are arranged to convert calculation results from the calculation unit 60 to output signals for conveying to signal receiving devices of other parts of the control arrangement 16.

The control arrangement 16 may comprise an output device 68, such as a screen, for displaying information to a farmer.

The control arrangement 16 may be at least partially implemented in a computer and/or a cloud-based system including a server located remote from the farm 4.0

Exemplified in FIG. 5 are connections of the calculation unit 60 with one each of a milk meter 28 of the milking entity 10, the animal identification system 12, the milk analysis device 14, and a signalling device 64 for notifying a farmer. Naturally, the number of such connections may correspond to the number of relevant devices in the arrangement 2 at the farm 4.

The control arrangement 16 may comprise more than one calculation unit 60 and more than one memory unit 62. For instance, the control arrangement 16 may be a distributed control arrangement with two or more separate calculation units, each configured for one or more particular tasks within the arrangement 2 at the farm 4, such as controlling opening and closing of entrance and exit gates leading the milking positions 18, controlling milking operations, analysing milk, etc, and/or each configured for controlling various devices at each milking position 18.

One or more databases may be stored in the memory unit 62.

A database over animal individuals at the farm 4 may include animal individual related data. The animal individual related data may be updated by a farmer and/or by data established in the milking entity 10, the animal identification system 12, and/or by results of analysed milk samples. The animal individual related data may include timestamps, such as the at least one timestamp for the milking event of each animal individual, the start timestamp, and the stop timestamp for one or more milking events, the milking position 18 in which an animal individual is milked, etc.

The database may include animal group related data, such as which animal individuals belong to which of the at least two groups of animals being milked in the milking entity 10, the group score for each group of animals, the feed fed to each group of animals, etc.

The database may include data provided by the milk analysis device 14, such as the values of the measured biomarker or constituent for each milk sample, milk sample timestamps, etc. The calculation unit 60 is connected to various parts and/or components of the arrangement 2 at the farm 4 to control their operation and/or receive data, etc.

One or more data tables may be stored in the memory unit 62. Examples of a data tables may be e.g.; a table containing one or more reference scores and/or a reference score ranges for the group score, a table containing minimum milk flow rates and/or minimum milk yields, etc.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the invention, as defined by the appended claims.

1. An arrangement for installation at a farm configured for providing a group score for at least a first group of animals based on a biomarker of milk or constituent in milk from the first group of animals, wherein the arrangement comprises:
A) a milking entity comprising:
i) a plurality of milking positions, each milking position comprising a milk extraction device and being configured for milking one animal individual at a time in a respective milking event; and
ii) a milk passageway arranged to transport milk from the plurality of milking positions towards a milk storage tank;
B) an animal identification system, wherein animal individuals of the first group of animals and a second group of animals are associated with a respective one of the first and second group of animals at a milking session in which the animal individuals of at least the first and second groups of animals are milked, the animal individuals being identifiable by the animal identification system, wherein a first animal individual and a last animal individual and any further animal individuals of the first group of animals are milked substantially simultaneously and/or successively at the milking session;
C) a milk analysis device configured to repeatedly receive milk samples from the milk passageway, resulting in a plurality of milk samples, the milk analysis device being configured to perform a milk analysis, to measure the biomarker or constituent of individual milk samples, and to provide a value of the measured biomarker or constituent for each individual milk sample; and
D) a control arrangement configured to:
obtain an animal identity of a respective animal individual being milked at the milking session in the milking entity from the animal identification system,
obtain or generate at least one timestamp for the milking event of each animal individual being milked at the milking session in the milking entity,
determine whether a respective animal individual being milked at the milking session in the milking entity belongs to the first group of animals,
store a first timestamp corresponding to the first animal individual of the first group of animals being milked at the milking session in the milking entity,
determine whether a respective animal individual being milked at the milking session in the milking entity belongs to the second group of animals, and, if the respective animal individual being milked at the milking session in the milking entity belongs to the second group of animals, store a second timestamp corresponding to the last animal individual of the first group of animals being milked at the milking session in the milking entity,
obtain or generate a milk sample timestamp for each milk sample of the plurality of milk samples,
obtain the value of the measured biomarker or constituent for each milk sample of the plurality of milk samples from the milk analysis device,
assign a group score to the first group of animals based on the values of the measured biomarker or constituent for the milk samples with milk sample timestamps within a time period from the first timestamp to the second timestamp.

2. The arrangement according to claim 1, wherein the control arrangement is further configured to:
determine a first instance in time when all animal individuals being milked substantially simultaneously at the milking session in the milking entity belong to the second group of animals,
store a third timestamp corresponding to the first instance in time,
determine whether a respective animal individual being milked at the milking session in the milking entity belongs to a third group of animals, and if so
store a fourth timestamp corresponding to a last animal individual of the second group of animals being milked at the milking session in the milking entity, and
assign a group score to the second group of animals based on the values of the measured biomarker or constituent for the milk samples with milk sample timestamps within a time period from the third timestamp to the fourth timestamp.

3. The arrangement according to claim 1, wherein the control arrangement is further configured to:
interrupt a taking of milk samples from the milk passageway in response to an identification of a first animal individual belonging to the second group of animals being milked at the milking session in the milking entity.

4. The arrangement according to claim 2, wherein the control arrangement is further configured to:
interrupt a taking of milk samples from the milk passageway in response to an identification of a first animal individual belonging to the second group of animals being milked at the milking session in the milking entity, and
resume the taking of milk samples from the milk passageway at the first instance in time.

5. The arrangement according to claim 1, wherein the control arrangement is further configured to:
compare the group score assigned to the first group of animals with a reference score and/or a reference score range, and
issue a signal if the group score assigned to the first group of animals deviates from the reference score and/or is outside the reference score range.

6. The arrangement according to claim 1, wherein the control arrangement is further configured to:
assign a start timestamp to a start of the milking event and a stop timestamp to a stop of the milking event for each animal individual, and
associate each individual milk sample of the plurality of milk samples with animal individuals having been milked based on the respective milk sample timestamp assigned to each individual milk sample and the start and stop timestamps for each animal individual.

7. The arrangement according to claim 1, wherein the control arrangement is further configured to:
associate each animal individual being milked at the milking session with one of the milking positions of the plurality of milking positions.

8. The arrangement according to claim 6, wherein each milk extraction device comprises a milk meter configured to provide milk flow rate data and/or milk yield data, and
wherein the control arrangement is further configured to:
associate each animal individual being milked at the milking session with one of the milking positions of the plurality of milking positions,
record milk flow rate and/or accumulated milk yield provided by the milk meters of the milk extraction devices as a function of time for each animal individual being milked at the miking occasion,
correlate the milk flow rate and/or the accumulated milk yield of animal individuals being milked at the milking session with individual milk samples based on the respective milk sample timestamps and the start and stop timestamps of each animal individual, and
determine a contribution to each individual milk sample of each animal individual being milked at the respective milk sample timestamp based on the associated milking position of each animal individual and on the milk flow rate and/or the accumulated milk yield of the animal individuals being milked at the respective individual milk sample timestamp.

9. The arrangement according to claim 1, wherein the milk passageway comprises a milk sample outtake, and
wherein the control arrangement is further configured to:
control that milk samples are repeatedly diverted from the milk passageway via the milk sample outtake to the milk analysis device.

10. The arrangement according to claim 9, wherein the control arrangement is further configured to:
control that the milk samples are diverted with a frequency within a range of 3-9 minutes.

11. The arrangement according to claim 1, wherein the plurality of milking positions are arranged on a rotary platform.

12. The arrangement according to claim 1, wherein the control arrangement is further configured to:
calculate an average group score for the first group of animals based on a plurality of group scores for the first group of animals assigned in a plurality consecutive milking sessions.

13. An arrangement comprising:
A) a milking entity configured for milking all animal individuals of a first group of animals substantially simultaneously and/or successively at a milking session, wherein the milking entity comprises:
i) a plurality of milking positions, each milking position comprising a milk extraction device and being configured for milking one animal individual at a time in a respective milking event; and
ii) a milk passageway arranged to transport milk from the plurality of milking positions towards a milk storage tank;
B) an animal identification system configured to identify in which one of at least the first group of animals and a second group of animals an animal individual belongs;
C) a milk analysis device is configured to obtain a plurality of milk samples from the milk passageway, the milk analysis device being configured to perform a milk analysis, to measure a biomarker of milk or a constituent in milk of individual milk samples of the plurality of milk samples, and to provide a value of the measured biomarker or the measured constituent for individual milk samples of the plurality of milk samples; and
D) a control arrangement configured to:
obtain an animal identity of a respective animal individual being milked at the milking session in the milking entity from the animal identification system,
obtain or generate at least one timestamp for the milking event of each animal individual being milked at the milking session in the milking entity,
determine whether a respective animal individual being milked at the milking session in the milking entity belongs to the first group of animals,
store a first timestamp corresponding to the first animal individual of the first group of animals being milked at the milking session in the milking entity,
determine whether a respective animal individual being milked at the milking session in the milking entity is a first animal individual that belongs to the second group of animals, and, when the respective animal individual being milked at the milking session in the milking entity is the first animal individual of the second group of animals, store a second timestamp corresponding to the last animal individual of the first group of animals being milked at the milking session in the milking entity,
obtain or generate a milk sample timestamp for each milk sample of the plurality of milk samples,
obtain the value of the measured biomarker or constituent for individual milk samples of the plurality of milk samples from the milk analysis device,
assign a group score to the first group of animals based on the values of the measured biomarker or constituent for the milk samples with milk sample timestamps within a time period from the first timestamp to the second timestamp.

14. An arrangement for use at a farm having a plurality of milking positions for milking animals distributed in one of at least a first group of animals and a second group of animals, a milk passageway arranged to transport milk from the plurality of milking positions towards a milk storage tank, and a milk analysis device configured to obtain a value of a measured biomarker or a constituent in milk for each of a plurality of milk samples, the arrangement being configured to:
obtain an animal identity of a respective animal individual being milked at a milking session from an animal identification system,
obtain or generate at least one timestamp for a milking event of each animal individual being milked at the milking session,
determine whether a respective animal individual being milked at the milking session belongs to the first group of animals,
store a first timestamp corresponding to the first animal individual of the first group of animals being milked at the milking session,
determine whether a respective animal individual being milked at the milking session is a first animal individual that belongs to the second group of animals, and, when the respective animal individual being milked at the milking session in the milking entity is the first animal individual of the second group of animals, store a second timestamp corresponding to the last animal individual of the first group of animals being milked at the milking session in the milking entity,
obtain or generate a milk sample timestamp for each milk sample of the plurality of milk samples,
obtain the value of the measured biomarker or the constituent in milk for each milk sample of the plurality of milk samples from the milk analysis device,
assign a group score to the first group of animals based on the values of the measured biomarker or constituent for the milk samples with milk sample timestamps within a time period from the first timestamp to the second timestamp.

15. The arrangement according to claim 14, wherein the arrangement is further configured to:
compare the group score assigned to the first group of animals with a reference score and/or a reference score range, and
issue a signal if the group score assigned to the first group of animals deviates from the reference score and/or is outside the reference score range.
